(19) United States
(12) Patent Application Publication
(10) Pub. No.: US 2026/0317119 A1
(43) Pub. Date: Oct. 15, 2026

(54) GENERATION OF CONTROL INTERFACE FOR A PEOPLE CONVEYOR SYSTEM

(71) Applicant: KONE CORPORATION, Helsinki (FI)

(72) Inventors: Zuhair ul HAQ, Helsinki (FI); Mari ZAKRZEWSKI, Helsinki (FI)

(73) Assignee: KONE CORPORATION, Helsinki (FI)

(21) Appl. No.: 19/444,337

(22) Filed: Jan. 9, 2026

Related U.S. Application Data
(63) Continuation of application No. PCT/FI2023/050450, filed on Aug. 1, 2023.

(51) Int. Cl. B66B 1/34; B66B 1/28

(52) U.S. Cl. CPC B66B 1/3407; B66B 1/28

(57) ABSTRACT

A computer-implemented method generates a control interface of a people conveyor system. The method includes: receiving data descriptive of a condition of at least one entity of the people conveyor system; defining at least one parameter for a 3-dimensional model of the people conveyor system corresponding to the people conveyor system; applying the at least one parameter in the 3-dimensional model; generating the control interface of the people conveyor system, by applying the at least one parameter in the 3-dimensional model. A computing entity, a computer program and a system for generating a control interface of a people conveyor system are provided.

### TECHNICAL FIELD

The invention concerns in general the technical field of people conveyor systems. More particularly, the invention concerns maintenance of people conveyor systems.

### BACKGROUND

Commonly applied way to perform a maintenance of people conveyor systems is to obtain measurement data with a number of sensors associated to the respective systems and the measurement data is analyzed locally and the information is transferred to a network side, such as to a data centre, wherein a decision with respect to a maintenance need is performed. In case it is decided that a maintenance operation is needed a service request is generated and a technician dispatches to the site the people conveyor system resides and take necessary actions to maintain the system.

The above-described service need based solution has a drawback in that the technician only gets the information on the service request only when there is a service need e.g. with respect to some specific components of the people conveyor system. However, the technicians do not have a deeper visibility to the operation of the people conveyor system nor to the monitoring of the system in general.

On the other hand, information with respect to the operational condition of the people conveyor system is only limited to the entity providing the maintenance services to the elevator. The building management personnel, i.e. the persons responsible of the operation of various systems and devices in a building, do not have access to the information with respect to the people conveyor systems and e.g. the maintenance operations may come as a surprise to the building management personnel. Even if the building management personnel may be provided with an access to the service requests with respect to the people conveyor systems residing in the building the information may contain technical information which might not be easy to understand by the building management personnel and it brings challenges e.g. in a communication of the service breaks of the people conveyor systems in the building.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a computer-implemented method, a computing entity, a computer program and a system for generating a control interface of a people conveyor system.

The objects of the invention are reached by a computer-implemented method, a computing entity, a computer program and a system for generating a control interface of a people conveyor system as defined by the respective independent claims.

According to a first aspect, a computer-implemented method for generating a control interface of a people conveyor system is provided, the method comprises:
receiving data descriptive of a condition of at least one entity of the people conveyor system, the data is based on measurement data generated with at least one sensor installed to the people conveyor system,
defining at least one parameter for a 3-dimensional model of the people conveyor system corresponding to the people conveyor system from which the data descriptive of the condition of the at least one entity of the people conveyor system is received, the at least one parameter is defined on a basis of the data descriptive of the condition of the at least one entity of the people conveyor system,
applying the at least one parameter in the 3-dimensional model of the people conveyor system,
generating the control interface of the people conveyor system, the control interface comprising the 3-dimensional model of the people conveyor system, wherein the at least one parameter applied in the 3-dimensional model of the people conveyor system causing the control interface to emphasize the at least one entity in the 3-dimensional model of the people conveyor system (300).

The data descriptive of the condition of the at least one entity of the people conveyor system may be received through a control device configured to collect measurement data from the at least one sensor.

For example, the at least one parameter may comprise data identifying the at least one entity to be emphasized in the 3-dimensional model of the people conveyor system.

The at least one entity to be emphasized may be selected based on the data descriptive of the condition of the at least one entity of the people conveyor system. For example, the selection of the at least one entity to be emphasized may be performed by comparing the data descriptive of the condition of the at least one entity of the people conveyor system to reference data.

Moreover, the generation of the control interface may be performed in a user-specific manner in accordance with a type of a user.

A control signal to control the people conveyor system may also be generated in response to an interaction of a user through the control interface. For example, the control is signal may be generated to a controller of the people conveyor system.

According to a second aspect, a computing entity is provided wherein the computing entity comprises a processor configured to perform the method according to the first aspect as defined above.

According to a third aspect, a computer program is provided, the computer program comprising instructions which, when the computer program is executed by a computer, cause the computer to carry out the method according to the first aspect as defined above.

According to a fourth aspect, a system for generating a control interface of a people conveyor system is provided, the system comprising:
a number of sensors installed to the people conveyor system,
at least one terminal device for outputting the control interface, and
at least one computing entity comprising a processor configured to perform the method according to the first aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a maintenance system according to an example.

FIG. 2 illustrates schematically a method according to an example.

FIG. 3 illustrates schematically a control interface according to an example.

FIG. 4 illustrates schematically an implementation of a computing entity according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

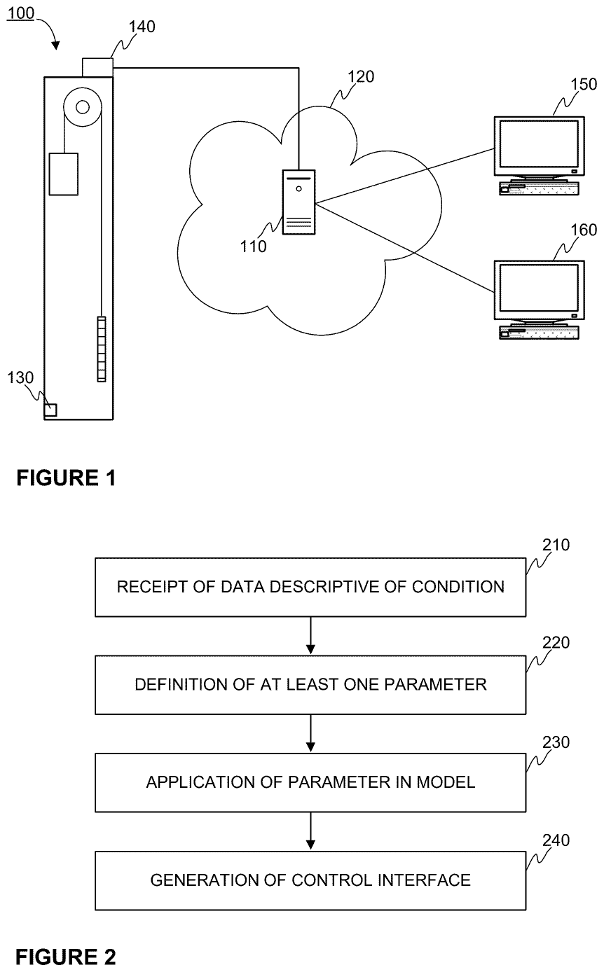

FIG. 1 illustrates schematically an example of a maintenance system of a people conveyor system 100 in accordance with the present invention. The people conveyor system 100 illustrated in FIG. 1 is an elevator system, but the invention is not only applicable with the elevator systems but may also be implemented with other types of people conveyor systems 100, such as with escalators and moving walkways. However, at least some aspects of the invention is herein mainly described in a context wherein the people conveyor system 100 is an elevator system.

The maintenance system according to at least some embodiments of the invention comprises a computing entity 110 which may be implemented with one or more computing devices, such as server devices. The computing entity 110 may be implemented in a communication network 120 e.g. as a cloud computing service. The computing entity 110 is configured to receive data descriptive of a condition of the people conveyor system 100. The data descriptive of the condition of the people conveyor system 100 shall be understood in a broad manner and may e.g. comprise data descriptive of a state of the people conveyor system 100, data descriptive of a state of one or more components of the people conveyor system 100, any combination of these, and so on. The term state may e.g. refer to a worn or a damage of the respective entity as a non-limiting example. Thus, the data received by the computing entity 110 is something that is descriptive of the condition of the people conveyor system 100, i.e. the entire system and/or one or more components therein. The term component may herein refer to a part, a device, a sub-system, a combination of any of these belonging to the people conveyor system 100.

The data descriptive of the condition of the people conveyor system 100 may be received from a number of sensors 130 associated to the people conveyor system 100. The sensor(s) 130 may be installed in locations desired to be monitored and they may be single-use case specific sensors or they may serve multiple purposes. For example, an oil level sensor may monitor the oil level in a guide rail of an elevator and counterweight oil cups in the elevator. On the other hand, a camera installed e.g. in an elevator shaft and/or on top and below of an elevator car may monitor doors, ropes, and other shaft components. For example, in a case that the people conveyor system 100 is an elevator the sensor(s) may be arranged to generate data by means of which the following operations may be performed:
Car door lock check
Guide rail and counterweight oil level measurements
Rope tension determination
Pit cleanness determination
Over-speed governor status check
Real-time car top and bottom video view
Pre-and Post-installation checks
Verification of generated service needs and fault codes.

For sake of clarity it is worthwhile to mention that the above-given list is not comprehensive and is mainly related to aspects relevant in an environment wherein the people conveyor system 100 is the elevator. However, corresponding aspects in other types of people conveyor systems 100 may be generated with applicable sensors 130 installed in applicable measurement positions.

The number of sensors 130 may be communicatively connected, by applying known communication technologies, to a control device 140 residing locally on the site of the people conveyor system 100 in question. Hence, the measurement data obtained with one or more sensors 130 may be delivered to the control device 140 which may be communicatively connected to the computing entity 110. The control device 140 may also be configured to perform pre-processing to the measurement data, which may comprise a manipulation of the measurement data, e.g. with statistical methods, and even analyzing of the measurement data and a result of the analyzation is delivered to the computing entity for further processing. The advantage in arranging the sensors to communicate with the local control device 140 is that there is a need to establish only one communication channel between the entities of the maintenance system residing at the people conveyor system end and the computing entity 110. However, the invention is not only limited to such an implementation and it may also be arranged that at least some of the sensors 130 are communicating directly with the computing entity 110.

In accordance with the present invention the computing entity 110 is configured to execute a computer program that generates a control interface for the people conveyor system 100 wherein the control interface comprises a 3-dimensional model of the people conveyor system 100. The 3-dimensional model of the people conveyor system 100 may e.g. refer to so-called digital twin model of the people conveyor system 100 and the 3-dimensional digitally implemented model is executed by the computing entity 110. In other words, the computing entity 110 is provided with an access to data representing a digital model of the people conveyor system 100 in question which digital model is executable by the computing entity 110, e.g. as a simulation model or as a live view dynamical model.

In the following it is referred to FIG. 2 which illustrates, as a method, at least some steps by means of which the control interface of the people conveyor system 100 may be generated by the computing entity 110 in accordance with the present invention.

In step 210 of FIG. 2 the computing entity 110 receives 210 data descriptive of a condition of at least one entity of the people conveyor system 100. The received data is based on measurement data generated with at least one sensor 130 installed to the people conveyor system 100. In other words, the computing entity 110 may receive the measurement data as it is or the received data may be (pre-)processed data from the measurement data.

In step 220 the computing entity 110 is configured to define 220 at least one parameter for a 3-dimensional model of the people conveyor system 100 corresponding to the people conveyor system 100 from which the data descriptive of the condition of the at least one entity of the real people conveyor system 100 is received. The at least one parameter is defined 220 by evaluating the received data and, thus, the at least one parameter is defined 220 on a basis of the data descriptive of the condition of the at least one entity of the people conveyor system 100. This refers to a process in which the computing entity 110 is configured to bring the data in a form that it may be applied in the 3-dimensional model for generating the control interface. In other words, an input parameters for the model are defined 220. In some embodiments the data may be brought into a form that it is descriptive on its content to a user of the system. The definition of the at least one parameter may correspond to an operation in which one or more measurement values from the measurement data are selected as an input or to an operation in which the received data is further processed, e.g. with statistical methods, to generate at least one parameter in the definition step 220. In some example embodiments of the invention the computing entity 110 may analyse the received data descriptive of the condition of the at least one entity, e.g. by comparing the data to reference data, i.e. to predefined reference data values, and to generate a detection result based on the analysis. The detection result may e.g. indicate if the condition of the at least one entity deviates from expected and as a result a parameter indicative of the deviation is defined. In accordance with the invention the parameters may define, such as identify, at least one entity from the 3-dimensional model of the people conveyor system corresponding to an entity in the real people conveyor system 100 at the site. The definition of the entity may be utilized in a manner as described in the forthcoming description.

Next, the computing entity 110 is configured to apply 230 the defined one or more parameters in the 3-dimensional model of the people conveyor system 100. This corresponds to that the computer program code executed by the computing entity 110 inputs the defined one or more parameters to the 3-dimensional model and the parameters are used in the 3-dimensional model. In response to the input of the one or more parameters the computing entity 110 is configured to generate 240 a control interface of the people conveyor system 100 with the 3-dimensional model of the people conveyor system 100 wherein the at least one parameter applied in the 3-dimensional model of the people conveyor system 100 causing the control interface to emphasize, such as to highlight, the at least one entity in the 3-dimensional model of the people conveyor system 100. The emphasizing of the at least one entity in the control system may correspond to a situation that the parameter applied in the 3-dimensional model identifies the entity as described and causes an effect of emphasizing, e.g. by highlighting, the respective entity. The identification of the entity may e.g. refer to a situation that the condition of the entity does not meet the requirements e.g. defined by the reference data and as a result it is desired that it is pointed out in the generated control interface so as to get notified by the user of the control interface. The deviation of the condition of the respective entity from the reference data may e.g. cause the definition of the at least one parameter for the 3-dimensional model as described.

The generation 240 of the control interface in the above-described manner corresponds to a situation that the computing entity 110 generates 240 the control interface to output in one or more terminal devices of the maintenance system. The terminal devices are referred with references 150 and 160 in FIG. 1. The terminal devices 150, 160 may be used by different stakeholders and in a sophisticated approach the computing entity 110 is configured to generate the control interface in a user-specific manner in accordance with a type of user using the terminal device 160, 170. The user-specific manner refers to an implementation in which the generated control interface differs between users, i.e. between user types, defined e.g. as user group manner. For example, the terminal device 150 may be used by a technician requested to provide service to the people conveyor system 100 and the technician is provided with another control interface with different functionalities than another user using the terminal device 160. The other user group may e.g. be the building management personnel. Hence, in accordance with a non-limiting example the technician(s) may be provided a control interface having more functionalities control accessibility than the building management personnel. In order to generate 240 such dedicated control interfaces the computing entity 110 may be provided with an access to data defining the different users, or user groups, with definitions of the control interface provided to the respective users. The users may e.g. be identified with known authentication procedures when accessing the maintenance system as described. Moreover, the terminal devices 150, 160 may be any applicable type of user devices, such as PCs, laptops, tablet computers, mobile phones, and so on.

The generated control interface for the users may advantageously be interactive which means that it may output the information e.g. on a display of a terminal device 150, 160, but also to receive input from the user with applicable input means, such as with keyboards, touchscreens, buttons, audio input devices and so on.

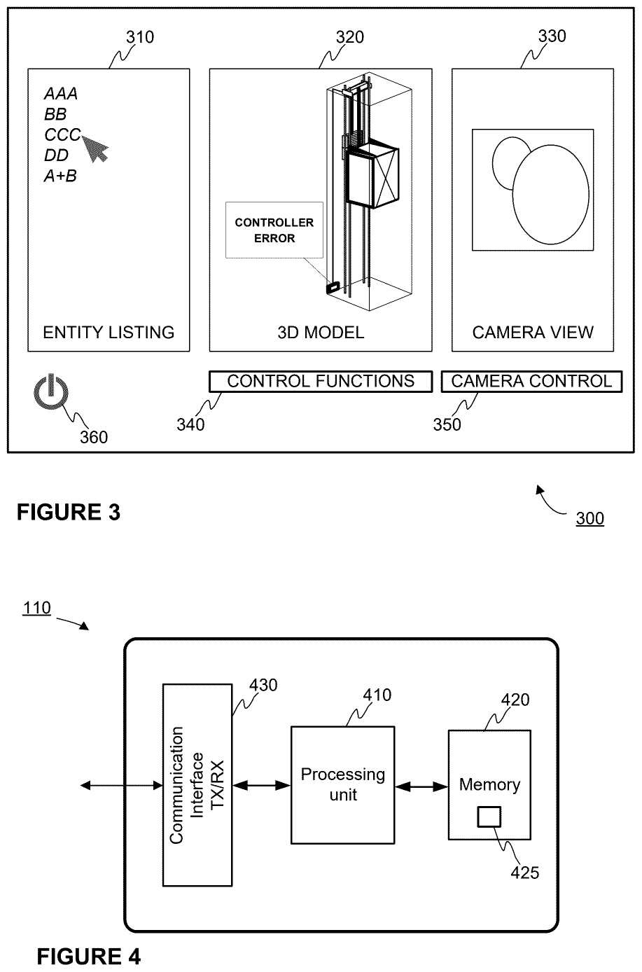

FIG. 3 illustrates schematically an example of the control interface 300 output on a display of the terminal device 150, 160 in order to interact with the user. The control interface 300 may be considered as a user interface comprising a number of information windows output to the user. For example, the control interface 300 may comprise a first information window 310 listing e.g. entities decided to be relevant based on the data received from the sensors. A second information window 320 may display the 3-dimensional model of the people conveyor system 100 in question in which the at least one entity is emphasized. In FIG. 3 the entity is emphasized with bolding it but also providing a callout box descriptive on some extent of the entity and a possible issue with respect to the entity. The types of emphasis are non-limiting examples and the emphasis may be performed in various ways, such as using different colors in showing the respective entity, blinking the entity, using audio output, and so on. The control interface 300 of FIG. 3 also comprises a third information window 330 which in this example is dedicated for providing real-time video stream from an elevator shaft wherein the real-time video stream, or individual images, may be captured with a number of cameras installed in the elevator system, such as in the elevator shaft. In some implementations at least one of the cameras may be rotatable and the field of view of the camera may e.g. be automatically or manually controlled towards the emphasized entity. Additionally, the control interface may comprise a number of icons enabling the user to control an operation of the control interface 300 and entities behind it. For example, the control interface 300 may comprise a first icon 340 which provides the user a control of the people conveyor system 100 and/or at least some entities therein. For example, in response to the emphasis of one or more entities in the 3-dimensional model in the second information window 320 the user may start controlling the respective entity in the real people conveyor system 100. For example, if the maintenance system informs the user, e.g. through highlighting, that an elevator door is malfunctioning, the user may start controlling the respective elevator door through with the control functions disclosed in the first icon 340. In some embodiments it may be arranged that prior to enabling the control of the respective entity the conveyor system is set to a maintenance mode which may cause an initiation of a predefined procedure with respect to the conveyor system. Such a procedure may e.g. comprise a generation of a predefined output e.g. through user interfaces of the conveyor system, such as a warning audio signal, in order to inform the users of the conveyors system on the maintenance mode. The controlling of the elevator door through the 3-dimensional model may correspond to that the user may open and close the respective elevator door in order to gather more measurement data for analysis. In this way the technician, for example, may receive more data in order to prepare for the visit on the site the real people conveyor system 100 operates. Alternatively, the testing of the elevator door may generate data that allows a decision-making that there is nothing wrong with the elevator door and this piece of information may be used for cancelling the service visit to the site. Moreover, the control interface may comprise further control icons denoted with 350 and 360 in FIG. 3 which allow the user to interact with other entities of the maintenance system, such as one of the sensors like camera. Also one of the icons (cf. 360) may be arranged for switching of the control interface 300. The control operations accessible from the control interface 300 may be case dependent and may comprise various control functions by means of which the people conveyor system 100 may be controlled to. This kinds of functions may e.g. be control of the door operation as described, control of a movement of the people conveyor system (cf. elevator car movement, a movement of escalator, a movement of moving walkway), testing operations to signaling devices, and so on.

The controlling of the people conveyor system 100 through the control interface 300 may be arranged so that the control interface 300, and the computer program implementing the control interface 300, is configured to generate control signals in accordance with the interaction of the user with the control interface 300. In other words, the user may indicate with the input means desired control tasks to the people conveyor system 100 and the indications are changed to control signals that are transmitted to the people conveyor system 100. In other words, the indications provided with the terminal device 150, 160 by the user are received by the computing entity 110 that is configured to generate the respective control signals to the people conveyor system 100. The generated control signals may be delivered to the people conveyor system 100 over a communication channel established between the computing entity 110 and the people conveyor system 100 wherein the communication channel may be dedicated for transferring the control data between the mentioned entities. In such an approach the communication channel is arranged between the computing entity 110 and a controller of the people conveyor system 100, such as an elevator controller in case of the people conveyor system is an elevator system. Corresponding controllers may also be found from the escalators and moving walkways. In some other embodiments the communication channel to the controller of the people conveyor system may be arranged through the control device 140 residing at the people conveyor system end. In such an approach the control device 140 is communicatively connected to the controller of the people conveyor system 100 and is capable of managing the communication so that the control signals are delivered to the respective controller. Without saying it is clear that the control signals carry data to the controller of the people conveyor system 100 that causes the desired entity in the people conveyor system 100 to operate in a desired manner when the controller of the people conveyor system 100 instructs the respective entity accordingly.

An example of an apparatus configurable to implement the operation of the computing entity 110 is schematically illustrated in FIG. 4. The apparatus may be configured to perform the method according to the invention as described with the examples in the foregoing description. Thus, the apparatus of FIG. 4 may be configured to perform a generation of a control interface of a people conveyor system 100. For sake of clarity, it is worthwhile to mention that the block diagram of FIG. 4 depicts some components of an apparatus that may be employed to implement a functionality of the computing entity. The apparatus of FIG. 4 comprises a processor 410 and a memory 420. The memory 420 may store data, such as pieces of data as described, but also computer program code 425 causing the operation in the described manner. In at least some embodiments, the apparatus may further comprise a communication interface 430, such as a wireless communication interface or a communication interface for wired communication, or both to communicate with other entities as described. The communication interface 430 may thus comprise one or more modems, antennas, and any other hardware and software for enabling an execution of the communication e.g. under control of the processor 410. Furthermore, I/O (input/output) components may be arranged, together with the processor 410 and a portion of the computer program code 425, to provide a user interface for receiving input from a user, such as from a technician, and/or providing output to the user of the apparatus when necessary. The user interface may e.g. refer to the control interface 300 as described. In particular, the I/O components may include user input means, such as one or more keys or buttons, a keyboard, a touchscreen, or a touchpad, etc. The I/O components may include output means, such as a loudspeaker, a display, or a touchscreen. The components of the apparatus may be communicatively connected to each other via data bus that enables transfer of data and control information between the components.

The memory 420 and at least a portion of the computer program code 425 stored therein may further be arranged, with the processor 410, to cause the apparatus to perform at least a portion of a method as is described herein. The processor 410 may be configured to read from and write to the memory 420. Although the processor 410 is depicted as a respective single component, it may be implemented as respective one or more separate processing components. Similarly, although the memory 420 is depicted as a respective single component, it may be implemented as respective one or more separate components, some, or all of which may be integrated/removable and/or may provide permanent/semi-permanent/dynamic/cached storage.

The computer program code 425 may comprise computer-executable instructions that implement functions that correspond to steps implemented in the method when loaded into the processor 410 of the respective control system. As an example, the computer program code 425 may include a computer program consisting of one or more sequences of one or more instructions. The processor 410 is able to load and execute the computer program by reading the one or more sequences of one or more instructions included therein from the memory 420. The one or more sequences of one or more instructions may be configured to, when executed by the processor 410, cause the apparatus, such as a computer, to perform a method as described. Hence, the apparatus may comprise at least one processor 410 and at least one memory 420 including the computer program code 425 for one or more programs, the at least one memory 420 and the computer program code 425 configured to, with the at least one processor 410, cause the apparatus implementing the computing entity to perform the method.

The computer program code 425, or at least some portion of it, may be provided e.g. a computer program product comprising at least one computer-readable non-transitory medium having the computer program code 425 stored thereon, which computer program code 425, when executed by the processor 410 causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 425 may comprise a proprietary ap-plication, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the entity performing the method in the role of the computing entity 110 may also be implemented with a plurality of apparatuses, such as the one schematically illustrated in FIG. 4, as a distributed computing environment. For example, one of the apparatuses may be communicatively connected with the other apparatuses, and e.g. share the data of the method, to cause another apparatus to perform at least one other portion of the method. As a result, the method performed in the distributed computing environment generates the control interface as described. The functionalities of the computing entity 110 as described may also be integrated to an entity configured also to perform other operations.

The specific examples provided in the description given above should not be construed as limiting the applicability and/or the interpretation of the appended claims. Lists and groups of examples provided in the description given above are not exhaustive unless otherwise explicitly stated.

1. A computer-implemented method for generating a control interface of a people conveyor system, the method comprises:
receiving data descriptive of a condition of at least one entity of the people conveyor system, the data is based on measurement data generated with at least one sensor installed to the people conveyor system,
defining at least one parameter for a 3-dimensional model of the people conveyor system corresponding to the people conveyor system from which the data descriptive of the condition of the at least one entity of the people conveyor system is received, the at least one parameter is defined on a basis of the data descriptive of the condition of the at least one entity of the people conveyor system,
applying the at least one parameter in the 3-dimensional model of the people conveyor system,
generating the control interface of the people conveyor system, the control interface comprising the 3-dimensional model of the people conveyor system, wherein the at least one parameter applied in the 3-dimensional model of the people conveyor system causing the control interface to emphasize the at least one entity in the 3-dimensional model of the people conveyor system.

2. The computer-implemented method according to claim 1, wherein the data descriptive of the condition of the at least one entity of the people conveyor system is received through a control device configured to collect measurement data from the at least one sensor.

3. The computer-implemented method according to claim 1, wherein the at least one parameter comprises data identifying the at least one entity to be emphasized in the 3-dimensional model of the people conveyor system.

4. The computer-implemented method according to claim 1, wherein the at least one entity to be emphasized is selected based on the data descriptive of the condition of the at least one entity of the people conveyor system.

5. The computer-implemented method according to claim 4, wherein the selection of the at least one entity to be emphasized is performed by comparing the data descriptive of the condition of the at least one entity of the people conveyor system to reference data.

6. The computer-implemented method according to claim 1, wherein the generation of the control interface is performed in a user-specific manner in accordance with a type of a user.

7. The computer-implemented method according to claim 1, wherein a control signal to control the people conveyor system is generated in response to an interaction of a user through the control interface.

8. The computer-implemented method according to claim 7, wherein the control is signal is generated to a controller of the people conveyor system.

9. A computing entity comprising a processor configured to perform the method according to claim 1.

10. A non-transitory computer-readable medium storing a computer program comprising instructions which, when the computer program is executed by a computer, cause the computer to carry out the method according to claim 1.

11. A system for generating a control interface of a people conveyor system, the system comprising:
a number of sensors installed to the people conveyor system,
at least one terminal device for outputting the control interface,
at least one computing entity comprising a processor configured to perform the method according to claim 1.

12. The computer-implemented method according to claim 2, wherein the at least one parameter comprises data identifying the at least one entity to be emphasized in the 3-dimensional model of the people conveyor system.

13. The computer-implemented method according to claim 2, wherein the at least one entity to be emphasized is selected based on the data descriptive of the condition of the at least one entity of the people conveyor system.

14. The computer-implemented method according to claim 3, wherein the at least one entity to be emphasized is selected based on the data descriptive of the condition of the at least one entity of the people conveyor system.

15. The computer-implemented method according to claim 2, wherein the generation of the control interface is performed in a user-specific manner in accordance with a type of a user.

16. The computer-implemented method according to claim 3, wherein the generation of the control interface is performed in a user-specific manner in accordance with a type of a user.

17. The computer-implemented method according to claim 4, wherein the generation of the control interface is performed in a user-specific manner in accordance with a type of a user.

18. The computer-implemented method according to claim 5, wherein the generation of the control interface is performed in a user-specific manner in accordance with a type of a user.

19. The computer-implemented method according to claim 2, wherein a control signal to control the people conveyor system is generated in response to an interaction of a user through the control interface.

20. The computer-implemented method according to claim 3, wherein a control signal to control the people conveyor system is generated in response to an interaction of a user through the control interface.
